(19) United States
(12) Patent Application Publication
(10) Pub. No.: US 2016/0034460 A1
(43) Pub. Date: Feb. 4, 2016

(54) METHOD AND SYSTEM FOR RANKING MEDIA CONTENTS

(71) Applicant: TCL RESEARCH AMERICA INC., Santa Clara, CA (US)

(72) Inventors: WANYING DING, Santa Clara, CA (US); YUE SHANG, Santa Clara, CA (US); LIFAN GUO, Santa Clara, CA (US); DAE HOON PARK, Santa Clara, CA (US); HAOHONG WANG, Santa Clara, CA (US)

(73) Assignee: TCL RESEARCH AMERICA INC.

(21) Appl. No.: 14/445,220

(22) Filed: Jul. 29, 2014

(51) Int. Cl. G06F 17/30; G06N 7/00; G06N 99/00

(52) U.S. Cl. CPC G06F 17/3053; G06N 99/005; G06N 7/005

(57) ABSTRACT

A method is provided for ranking media contents. The method includes receiving media contents through a network and extracting feature values of the received media contents. The method also includes implementing a parameter reinforcement learning process to obtain automatically distribution over relativeness and irrelativeness of the received media contents. Further, the method includes ranking the received media contents by a multi-armed bandit algorithm based on the obtained distribution over relativeness and irrelativeness of the received media contents.

### FIELD OF THE INVENTION

The present invention generally relates to the field of information technology and user interface technologies and, more particularly, to methods and systems for ranking media contents.

### BACKGROUND

Ranking is a classical research area in information science. In traditional ranking methods, people simply use metadata, such as titles, authors or keywords as entries to rank items. With the explosive growth of information, people require more efficient ranking methods to help them discover related messages more accurately and quickly.

However, many traditional ranking algorithms used in current social review systems have a lot of limitations on input features. Social media information is characterized as big volume, high velocity, numerous varieties and countless variability. Taking a well-known PageRank algorithm as an example, the PageRank requires page source information, and link information among different pages. In many situations, such information is unavailable. For example, if a user wants to rank a list of reviews according to helpfulness of the reviews, the PageRank may be powerless, because it is hard to obtain one arbitrary review's authority and link information.

The disclosed methods and systems are directed to solve one or more problems set forth above and other problems.

### BRIEF SUMMARY OF THE DISCLOSURE

One aspect of the present disclosure includes a method for ranking media contents. The method includes receiving media contents through a network and extracting feature values of the received media contents. The method also includes implementing a parameter reinforcement learning process to obtain automatically distribution over relativeness and irrelativeness of the received media contents. Further, the method includes ranking the received media contents by a multi-armed bandit algorithm based on the obtained distribution over relativeness and irrelativeness of the received media contents.

Another aspect of the present disclosure includes a system for ranking media contents. The system includes a feature extraction module configured to extract feature values of the received media contents. The system also includes a self-learning module configured to implement a parameter reinforcement learning process to obtain automatically distribution over relativeness and irrelativeness of the received media contents. Further, the system includes a ranking module configured to rank the received media contents by a multi-armed bandit algorithm based on the obtained distribution over relativeness and irrelativeness of the received media contents.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary environment incorporating certain embodiments of the present invention;

FIG. 2 illustrates an exemplary computing system consistent with the disclosed embodiments;

FIG. 3 illustrates a structure schematic diagram of an exemplary personalized video contents delivery system consistent with the disclosed embodiments;

FIG. 4 illustrates a flow chart of an exemplary personalized video contents delivery process consistent with the disclosed embodiments;

FIG. 5 illustrates an example of scaling the value to 1 to 10 according to a normal Cumulative Distribution Function (CDF) function consistent with the disclosed embodiments; and

FIG. 6 illustrates an exemplary probabilistic model consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

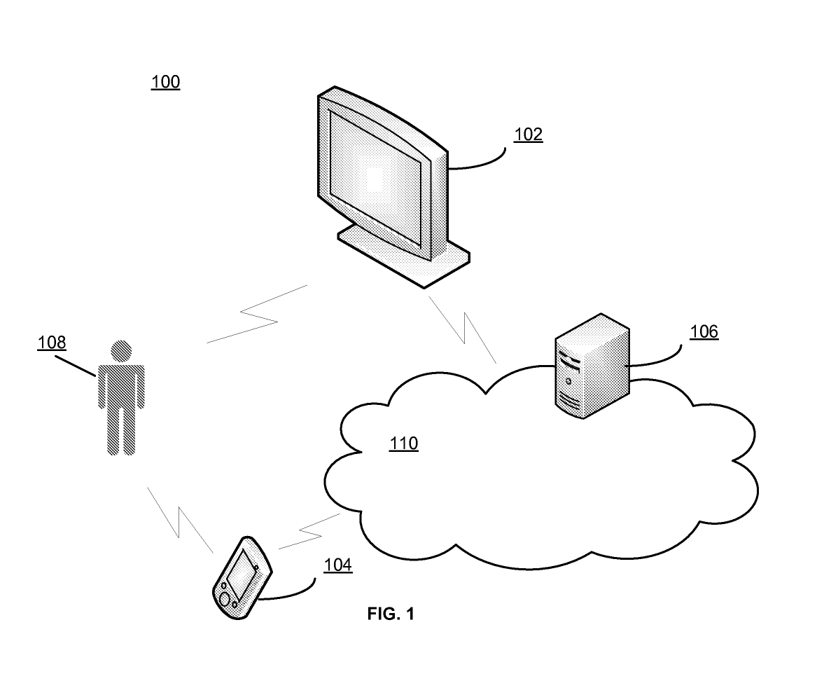

FIG. 1 illustrates an exemplary environment 100 incorporating certain embodiments of the present invention. As shown in FIG. 1, environment 100 may include a television set (TV) 102, a smart phone 104, a server 106, a user 108, and a network 110. Other devices may also be included.

TV 102 may include any appropriate type of TV, such as plasma TV, LCD TV, projection TV, non-smart TV, or smart TV. TV 102 may also include other computing system, such as a personal computer (PC), a tablet or mobile computer, or a smart phone, etc. Further, TV 102 may be any appropriate content-presentation device capable of presenting multiple programs in one or more channels.

Smart phone 104 may be an iOS phone, an Android phone, a blackberry phone, or any other computing mobile device capable of performing a web browsing function.

Further, the server 106 may include any appropriate type of server computer or a plurality of server computers for providing personalized media contents to the user 108. The server 106 may also facilitate communication, data storage, and data processing for the smart phone 104 and/or TV 102. TV 102 and/or smart phone 104, and server 106 may communicate with each other through one or more communication networks 110, such as a cable network, a phone network, and/or a satellite network, etc.

The user 108 may interact with TV 102 and/or smart phone 104 to watch various programs, browse webpages and perform other activities of interest. The user 108 may be a single user or a plurality of users, such as family members watching TV programs together.

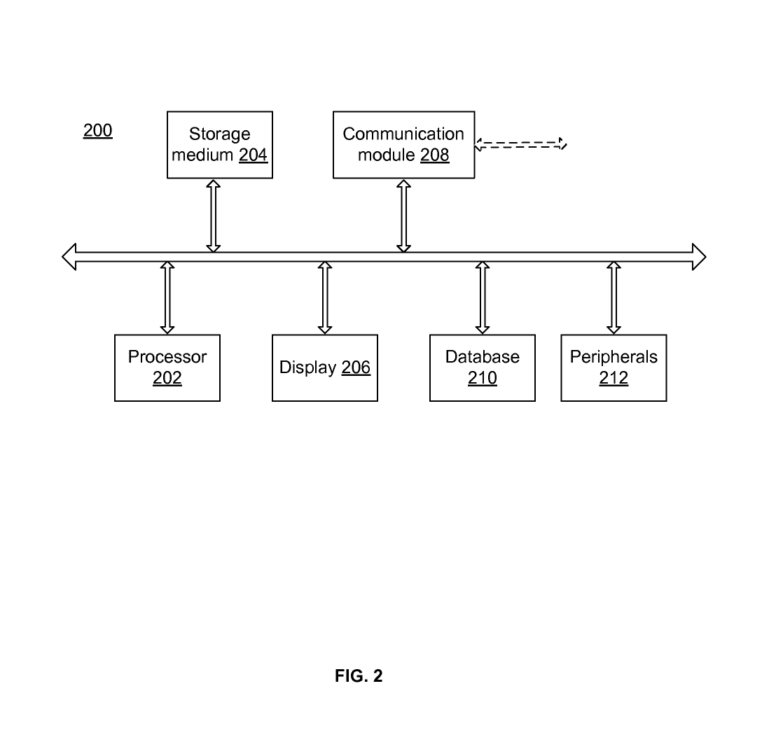

TV 102, smart phone 104, and/or server 106 may be implemented on any appropriate computing circuitry platform. FIG. 2 shows a block diagram of an exemplary computing system 200 capable of implementing TV 102, smart phone 104, and/or server 106.

As shown in FIG. 2, computing system 200 may include a processor 202, a storage medium 204, a display 206, a communication module 208, a database 210, and peripherals 212. Certain devices may be omitted and other devices may be included.

Processor 202 may include any appropriate processor or processors. Further, processor 202 can include multiple cores for multi-thread or parallel processing. Storage medium 204 may include memory modules, such as ROM, RAM, flash memory modules, and mass storages, such as CD-ROM and hard disk, etc. Storage medium 204 may store computer programs for implementing various processes, when the computer programs are executed by processor 202.

Further, peripherals 212 may include various sensors and other I/O devices, such as keyboard and mouse, and communication module 208 may include certain network interface devices for establishing connections through communication networks. Database 210 may include one or more databases for storing certain data and for performing certain operations on the stored data, such as database searching.

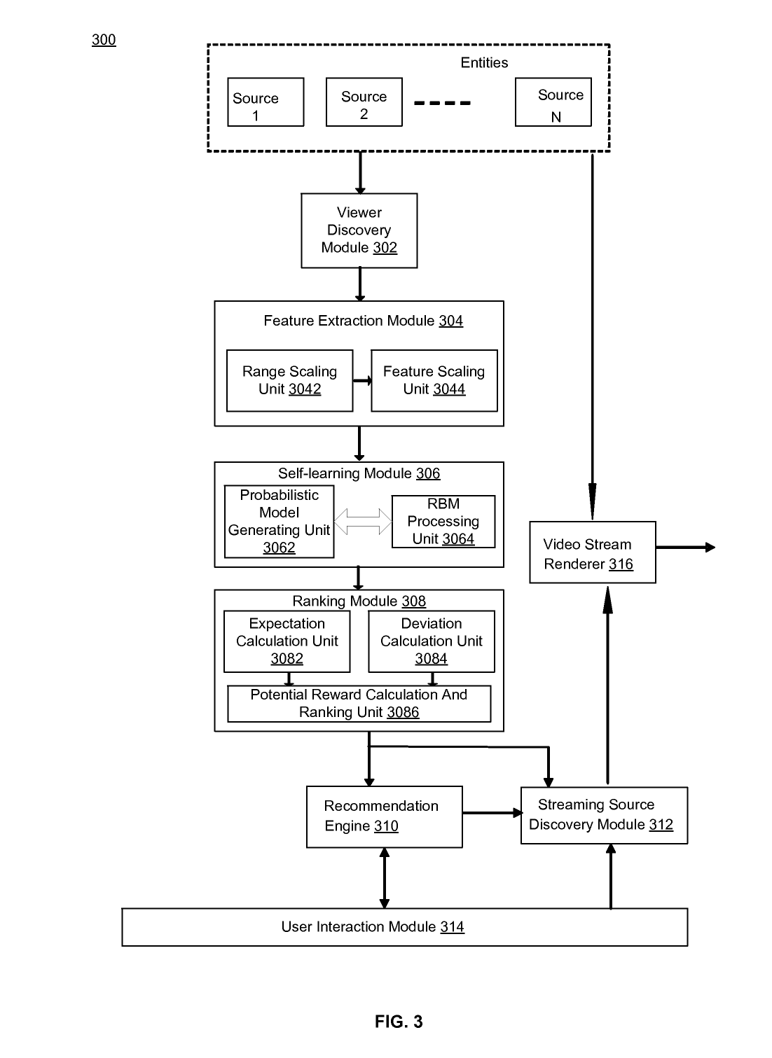

Online social review systems may be integrated on smart TV systems and/or smart phones to help organize and share socially produced information valuable to assist in making purchasing decisions, choosing movies, choosing services and shops, renting DVDs, buying books, etc. FIG. 3 illustrates a structure schematic diagram of an exemplary personalized video contents delivery system consistent with the disclosed embodiments. The personalized content delivery system may recommend media contents based on ranking of available media contents.

As shown in FIG. 3, the content delivery system 300 may include a viewer discovery module 302, a feature extraction module 304, a self-learning module 306, a ranking module 308, a recommendation engine 310, a streaming source discovery module 312, a user interaction module 314, and a video stream renderer 316. Certain components may be omitted and other components may be added.

The viewer discovery module 302 is configured to detect a viewing activity of at least one user of a content-presentation device capable of presenting multiple programs in one or more channels, and to determine a plurality of user identities of the at least one user.

The feature extraction module 304 is configured to extract feature values of the received media contents. The feature extraction module 304 may include a range scaling unit 3042 and a feature scaling unit 3044. The range scaling unit 3042 is configured to generate a reasonable range based on feature lists of entities. The entities may include any appropriate type of source for media contents and may contain various video sources (i.e., video source 1, video source 2, . . . video source n). The contents from the entities may include both video data and reviews of the entities (e.g., movies). The feature scaling unit 3044 is configured to scale feature values into a reasonable range to distinguish different entities.

The self-learning module 306 may be configured to implement a parameter reinforcement learning process to obtain automatically distribution over relativeness and irrelativeness of the received media contents. The self-learning module 306 may include a probabilistic model generating unit 3062 and a Restricted Boltzmann Machine (RBM) processing unit 3064. The probabilistic model generating unit 3062 is configured to construct a probabilistic model and infer the parameters by Markov Chain Monte Carlo. The Restricted Boltzmann Machine (RBM) processing unit 3064 is configured to implement a self-learning process by RBM.

The ranking module 308 is configured to rank the received media contents by a multi-armed bandit algorithm based on the obtained distribution over relativeness and irrelativeness. The ranking module 308 may include an expectation calculation unit 3082, a deviation calculation unit 3084, and a potential reward calculation and ranking unit 3086. The expectation calculation unit 3082 is configured to calculate each entity's estimated expectation [symbol] in R reviews. The deviation calculation unit 3084 is configured to calculate each entity's standard deviation [symbol] in the R reviews. An upper confidence bound is [symbol] +λ [symbol] where λ is a confidence level (or a confidence coefficient). To be simple, λ is set as 1. The potential reward calculation and ranking unit 3086 is configured to calculate the upper confidence bound of each review and rank the R reviews according to the upper confidence bounds of the R reviews.

Based on ranked results generated by the ranking module 308, the recommendation engine 310 may select personalized contents to recommend to the user. That is, once the ranked results are generated, the recommendation engine 310 may be configured to handle video content selection and to recommend preferred contents for the user 108. In certain embodiments, the recommendation engine 310 may further provide video content selection and recommendation information to streaming source discovery module 312 to stream video data to the user.

Based on information from the recommendation engine 310, the streaming source discovery module 312 may select the best source to obtain the video stream and control the video stream renderer to playback the video streaming from the selected source. That is, the streaming source discovery module 312 may implement a user-adaptive streaming source discovery mechanism to enable the streaming data source selection optimization according to various constraints from the user 108, such as a home network condition, a terminal condition, a video-on-demand (VOD) service subscription, etc., and/or from a service provider or server 106, such as a regional constraint and cloud computational capability constraint, etc.

The user interaction module 314 may be configured to implement interactions between the system 300 and the user 108 based on any appropriate interaction mechanisms, such as keyboard/mouse, remote control, sensors, and/or gesture/voice control, etc.

Further, the video stream renderer 316 may be configured to generate personalized video stream and to transmit the personalized video stream to the user 108 (e.g., to TV 102) based on the configuration from the streaming source discovery module 312 and from the entities.

In certain embodiments, the video stream renderer 316 together with the streaming source discovery module 312 may deliver the personalized video stream over a particular program channel on TV 102. That is, for a particular user 108, a program channel can be configured to recommend video contents to the user based on the ranked results from the online reviews, and to deliver the personalized video contents to the user over that particular channel.

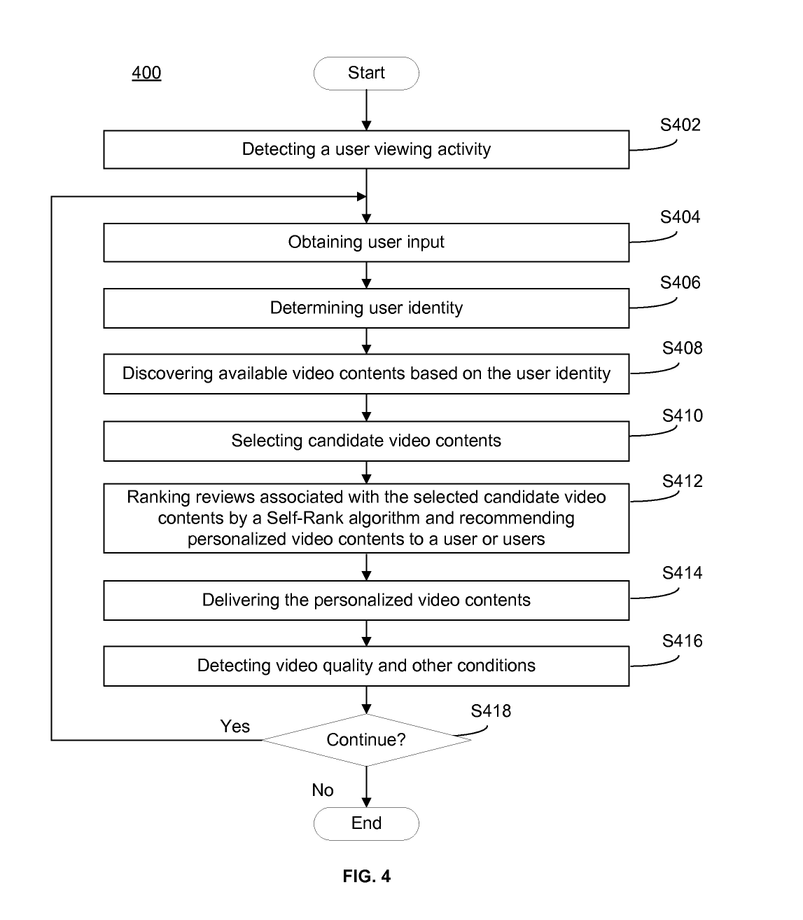

In operation, personalized content delivery system 300 may perform certain processes to deliver personalized contents to users. FIG. 4 illustrates a flow chart of an exemplary process 400 for delivering personalized video contents to users.

As shown in FIG. 4, at the beginning, a user viewing activity may be detected (S402). For example, the user may turn on TV 102 to communicate with TV 102 or server 106. After the user activity is detected, any user input may be obtained (S404).

For example, if a user uses a wearable device, such as a smart phone, the device may interact with TV 102 to exchange certain user data. If the user just turns on TV, certain program selection of the user may also be obtained.

Further, the identity of the user or users may be determined (S406). For example, when the users have wearable devices, such as a bracelet, watch or a mobile phone, the devices may be wirelessly connected to the TV 102 and the user identity may be communicated to TV 102. This way, the user identity can be easily determined. The user identity may also be easily determined if TV 102 is equipped with face or user recognition technology. Further, when a smart remote control used by a user, the user's identity who is using the remote control can be obtained with reasonably high accuracy. However, other viewers who maybe also sitting there cannot be detected.

When there are no supporting devices available, the TV viewer information is not traceable but the viewing history may reveal certain viewing patterns. The identity of the user may be determined based on the content correlation and relevance. For example, a user typically watches soap every other day, but sometimes he/she controls the remote control, and sometimes others take control. In such a case, the viewing patterns of a user can be obtained by performing a pattern mining.

After the user identity is determined, the available video contents may be discovered or determined based on the user identity (S408). That is, a content discovery may be performed by the system 300 (e.g., server 106).

Further, the system 300 may select candidate video contents based on the discovered video contents (S410).

In addition, the system 300 may use a Self-Rank algorithm to rank reviews associated with the selected candidate video contents and make a recommendation on personalized video contents to the user or users based on the ranked results generated by the Self-Rank algorithm (S412).

The Self-Rank algorithm has no limitation on the input features. Actually, the users can define any kinds of features in ranking. For example, in order to rank online reviews, users can use the review length, review's entropy, review's sentiment polarity, reviews readability as the features. To rank movies, the users can use favorite actors/actresses' information, plot description and publish time as features. Thus, each entity is represented as a list of features as shown as follows:

$$\begin{matrix}{E}_{1} {=}^{Δ} ( {f}_{11} , {f}_{12} … {f}_{1 k} ) & ( 1 ) \\ {E}_{2} {=}^{Δ} ( {f}_{21} , {f}_{22} … {f}_{2 k} ) & ( 2 ) \\ … & \\ {E}_{n} {=}^{Δ} ( {f}_{n 1} , {f}_{n 2} … {f}_{nk} ) & ( 3 )\end{matrix}$$

where Eₙ is the n^{th} entity, and fₙⱼ is the i^{th} feature of the n^{th} entity.

Traditionally, a binary feature value (namely 0 and 1) mechanism is used to represent features. If an entity meets a criterion, the entity has a 1 value on that feature; otherwise the entity has a 0 value on that feature. The problem of this mechanism is that there are a lot of entities sharing the same feature list, especially when there are a limited number of features but a huge number of entities to analyze. On the other hand, a binary mechanism is too coarse to distinguish entities. For example, reviews with 10 words have the same value as the review with 100 words when the length threshold is 9 words. This may be unreasonable.

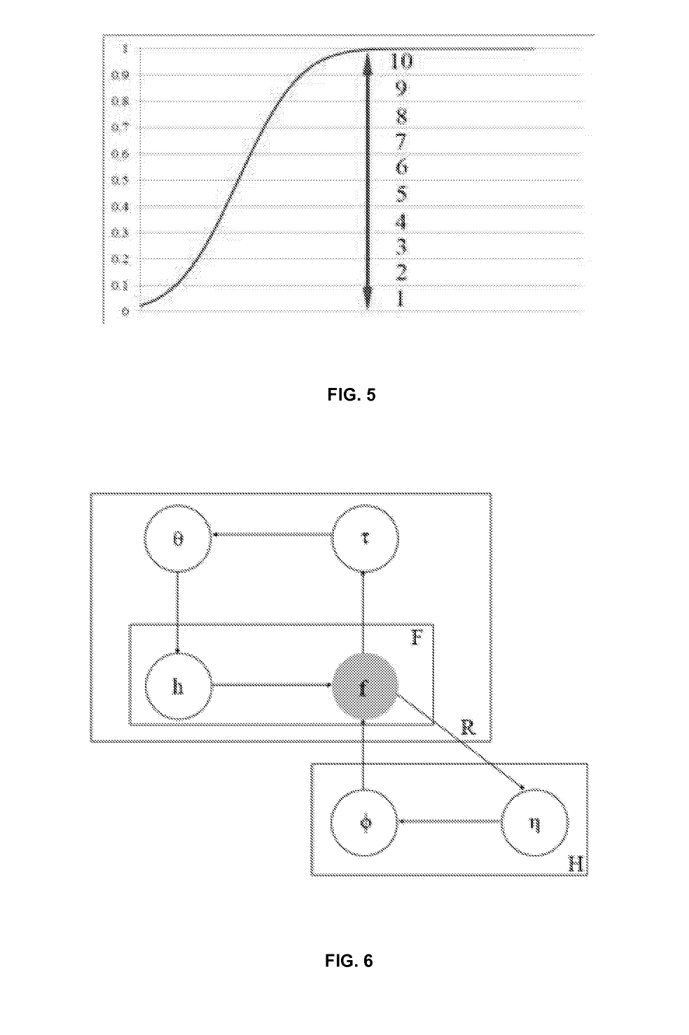

The Self-Rank allows users to scale feature values into a reasonable range. Taking review length as an example, if there are 1000 reviews with average length of μ_{Len} and the deviation of σₗₑₙ, a normal distribution Mₗₑₙ(μ_{Len}, σₗₑₙ) for the length distribution can be constructed by acquiescing in the theory that most things obey a normal distribution. Therefore, each review can be given a value according to the Cumulative Distribution Function (CDF). FIG. 5 shows an example of scaling the value to 1 to 10 according to a normal CDF function.

As shown in FIG. 5, the value of a cumulative distribution function of a continuous probability distribution is scaled to 1 to 10. Thus, the Self-Rank algorithm uses all the features together to rank the items and has so specific requirement on each feature. Therefore, the users have the maximum freedom and flexibility in feature determinations. In addition, the scaling mechanism can help to distinguish different entities, improving the ranking result.

A probabilistic model is constructed to realize the parameter reinforcement learning, and Markov Chain Monte Carlo is used to infer the parameters.

In order to find whether an entity is relative or not, a latent variable hε{0,1} is introduced to denote the entities relativeness. Because relativeness/irrelativeness is a bivariate distribution problem, a Beta distribution is selected. Thus, it is defined that the latent variable h obeys a Beta Distribution.

FIG. 6 illustrates an exemplary probabilistic model consistent with the disclosed embodiments. As shown in FIG. 6, it is assumed that R entities need to be ranked, and there are F features in total. All of these R entities have a Beta distribution on relativeness/irrelativeness, which is denoted by the latent variable h, and h has a Multinomial distribution on the features. The latent variable h is the one that the users want to obtain; f is the known feature vectors; θ and φ are the parameters that need to be inferred; and τ and η are hyper parameters.

The generating process of this model may include the following steps.

Step 1: for each latent variable h, a distribution φ₁ is generated according to the hyper parameter η.

φₗ˜Dir(η) (4)

Step 2: for each entity r, a Beta distribution is generated according to the hyper parameter τ.

fᵣ˜Beta(τ) (5)

Step 2-1: the hyper parameters are updated by update(τ) and update(η).

Step 2-2: for each feature position f in the review, a label l_{r,f} is generated according to this review's distribution on relativeness/irrelativeness.

l_{r,f}˜Bern(θ) (6)

Step 2-3: for each feature position, a feature is generated according to the helpful label l_{r,f}, and this feature's distribution φₗ on relativeness/irrelativeness.

f˜Mult(φₗ,l_{r,f}) (7)

A Gibbs Sampling is used to conduct the inference. The Gibbs sampling is a Markov chain Monte Carlo (MCMC) algorithm for obtaining a sequence of observations which are approximated from a specified multivariate probability distribution, when direct sampling is difficult. According to the model described as the above, the probabilistic formula of this model can be defined by:

$$\begin{matrix}p ( f , l , θ , φ \vert τ , η ) = Beta ( θ \vert τ ) * Dir ( φ \vert η ) * Bern ( l \vert θ ) * \\ Mult ( f \vert l , φ ) ) \\ = \frac{Γ ( {τ}_{1} , {τ}_{2} )}{Γ ( {τ}_{1} ) * Γ ( {τ}_{2} )} * {θ}^{{τ}_{1} - 1} * {( 1 - θ )}^{{τ}_{2} - 1} * \\ {\prod }_{i = 1}^{F} {\prod }_{l = 1}^{H} {φ}_{i , l}^{{η}_{i , l} - 1} * \frac{Γ ( {\sum }_{i = 1}^{F} {η}_{i} )}{{\prod }_{i = 1}^{F} Γ ( {η}_{i} )} * \\ {θ}^{{N}_{r , {l}_{1}}} * {( 1 - θ )}^{{N}_{r , {l}_{2}}} * {\prod }_{i = 1}^{F} {\prod }_{l = 1}^{H} {φ}_{{f}_{i}}^{{N}_{l}}\end{matrix} \qquad ( 8 )$$

Then, by Bayesian transformation, the following formula 9 can be obtained.

$$p ( {f}_{i} = l \vert {f}_{- i} , l , θ , φ , τ , η ) ∝ \frac{{N}_{r , l} + {τ}_{r , l}}{{\sum }_{l = 1}^{H} ( {N}_{r , l} + τ r {,}_{l}} * \frac{{N}_{l , {f}_{i}} + {η}_{l , i}}{{\sum }_{i = 1}^{F} ( {N}_{l , {f}_{i}} + {η}_{l , i} )} \qquad ( 9 )$$

where N_{r,l} is the number of features in review r that is assigned to a helpful label l; τ_{r,l} is the hyper parameter for the r^{th} review on the helpfulness label l; N_{l,f}_{ᵢ} is the number of feature i that is assigned to the helpful label l; and η_{l,i} is the hyper parameter of the i^{th} feature of the l^{th} label.

Further, for each entity, the parameter π˜θ(a,b) can be obtained by counting how many features are assigned to the relative label, and how many features are assigned to irrelative one.

Further, in the above probabilistic model, the problem here is how to decide the values of the hyper parameters τ and η in the model. In addition, the values of the hyper parameters can affect the final results. The Self-Rank algorithm can learn the values of the hyper parameters by itself. The Restricted Boltzmann Machine (RBM) is implemented to facilitate such learning.

The classical RBM is an extension of neural network, including two layers of units, that is, one layer of hidden units (the latent factors that the system tries to learn) and one layer of visible units (e.g., users' movie preferences whose states the system know and set). Furthermore, each visible unit is connected to all the hidden units (this connection is undirected, so each hidden unit is also connected to all the visible units). Between the hidden layer and the visible layer, there is a symmetric matrix of weights W=(w_{i,j}) that connects the visible unit vᵢ and the hidden unit hⱼ. In addition, there are two other kinds of variables aᵢ and bⱼ. The bias weight aᵢ is for the visible units, and the bias weight bⱼ is for the hidden units.

In the RBM, the hidden unit activations are mutually independent given the visible unit activations and conversely, the visible unit activations are mutually independent given the hidden unit activations. The v₁ is set as the observed data (i.e., a training sample), w_{i,j} is the weight of the connection between i and j and is initiated according to a normal distribution N(0,0.01), aᵢ is initiated as 1.0/N, where N is the number of visible nodes in total, and bⱼ is initiated as 0. σ(x) denotes the logistic sigmoid function σ(x)=1/(1+exp(−x)). Then, each iteration process of RBM includes the following steps.

Step 1: for each hidden unit, the individual activation probability (that is, the conditional probability of a configuration of the hidden unit h_{1,j}, given a configuration of the visible unit v₁) is calculated by:

P(h_{1,j}=1|v₁)=σ(aᵢ+Σᵢv_{1,i}*w_{i,j}) (10)

where v₁ is set as the observed data; the weight w_{i,j} is initiated according to a normal distribution N(0,0.01); a denotes the logistic sigmoid; and the bias weight aᵢ for the visible units is initiated as 1.0/N.

Step 2: for each visible unit, the individual activation probability (that is, the conditional probability of a configuration of the visible unit v_{2,i}, given a configuration of the hidden unit h₁) is calculated by:

P(v_{2,i}=1|h₁)=σ(bⱼ+Σⱼh_{1,j}*w_{i,j}) (11)

where the weight w_{i,j} is initiated according to a normal distribution N(0,0.01); σ denotes the logistic sigmoid; and the bias weight bⱼ for the hidden units is initiated as 0.

Step 3: for each hidden unit, the individual activation probability (that is, the conditional probability of a configuration of the hidden unit h_{2,j}, given a configuration of the visible units v₂) is calculated by:

P(h_{2,j}=1|v₂)=σ(aᵢ+Σ_{2,i}*w_{i,j}) (12)

where the weight w_{i,j} is initiated according to a normal distribution N(0,0.01); Cr denotes the logistic sigmoid; and the bias weight aᵢ for the visible units is initiated as 1.0/N.

Therefore, the updated latent variables can be represented by:

W=W+lr*(P(h₁=1|v₁)v₁^{T}−P(h₂=1|v₂)v₂^{T}) (13)

a=a+lr*(v₁−v₂) (14)

b=b+lr*(P(h₁=1|v₁)−P(h₂=1|v₂)) (15)

where lr is a learning rate. P(h₁=1|v₁)v₁^{T} measures the association between the visible unit and the hidden unit that the system wants the network to learn from the training sample. Because the RBM generates the states of visible units based on its hypotheses about the hidden units alone in step 3, P(h₂=1|v₂)v₂^{T} measures the association that the network itself generates when no units are fixed to training data.

The weight vector W is used to infer the hyper parameter η for feature-helpfulness distribution. For a feature fᵢ, the prior distribution on a helpful label lⱼ may be calculated by:

η_{i,j}=e^{w}^{_{i,j}}^{*κ} (16)

where κ is the magnification coefficient to range η_{i,j} to a suitable magnitude.

The values of (P(h₁=1|v₁) and P(h₂=1|v₂) are used to infer the hyper parameter τ. For a review r, the prior distribution on a helpful label lⱼ can be calculated by:

$${τ}_{r , j} = \frac{P ( {h}_{rj , 1} = 1 \vert {v}_{r , 1} ) + P ( {h}_{rj , 2} = 1 \vert {v}_{r , 2} )}{2} \qquad ( 17 )$$

Thus, every entity's distribution over relativeness/irrelativeness can be automatically obtained. The process for ranking these entities includes the followings.

Because each entity is used as an independent distribution, a Multi-Armed Bandit (MAB) algorithm is used to rank the items. The MAB is an algorithm to deal with gambling problem by helping gamblers to decide in which sequence plays the gambling machines in order to maximize the total reward. There are many ways to realize a MAB process. An upper confidence bound 1 (UCB1) algorithm is a classical one. The UCB1 may achieve logarithmic regret uniformly over the reviews and require no preliminary knowledge about the reward distribution.

The principle of UCB1 is that, R reviews is acted as R independent machines to play with, and each machine i can be described as a distribution Pᵢ. Each time the machine with maximize upper confidence bound is selected to play. Thus, the selected machine can either has a high estimated reward, or have a high uncertainty. However, the UCB1 doesn't care much about the uncertainty part, but just wants to get the reviews with high reward. Thus, an average reward is used as the upper confidence bound.

Actually, each entity's average reward μᵣ can be inferred by its estimated expectation [symbol] and standard deviation [symbol] . According to Chebyshev's inequality

$$Pr ( \vert {μ}_{r} - \vert \geq λ ) \leq \frac{1}{{λ}^{2}} \qquad ( 18 )$$

Further, if λ is large enough, the following formula is correct.

|μᵣ− [symbol] |≦λ [symbol] (19)

μᵣ− [symbol] ≦λ [symbol] (20)

μᵣ≦ [symbol] +λ [symbol] (21)

Therefore, the upper confidence bound is [symbol] +λ [symbol] . To be simple, λ is set as 1. If the every entity's estimated expectation and its standard deviation can be obtained, the reviews can be ranked according to its upper confidence bound.

From the probabilistic model, each entities distribution over relativeness/irrelativeness which obeys a Beta distribution Beta(πᵣ) can obtained. Thus, this distribution can be used to help accomplish the rank task. Each entity has a Beta distribution parameter vector(π_{r,α}, π_{r,β}). π_{r,α} and π_{r,β} are independent, where π_{r,α} indicates the probability of this review to be helpful, and π_{r,β} indicates the probability to be unhelpful. When the parameter vector πᵣ of each review is known, the estimated expectation and standard variance of this review can be calculated by:

$$\begin{matrix}= \frac{{π}_{r , α}}{{π}_{r , α} + {π}_{r , β}} & ( 22 ) \\ = \sqrt{\frac{{π}_{r , α} * {π}_{r , β}}{{( {π}_{r , α} + {π}_{r , β} )}^{2} * ( {π}_{r , α} + {π}_{r , β} + 1 )}} & ( 23 )\end{matrix}$$

where shape parameters α, β>0.

Returning to FIG. 4, based on the content recommendation and/or user selection, the system 300 may deliver the personalized video contents to the user (S414). For example, the system 300 may generate video stream based on configuration information on the user identity and recommendation from a particular content pool or pools. The video stream may then be transmitted to the TV 102 and the user or users. TV 102 may present the video stream in a single dedicated channel for the personalized contents. That is, the personalized contents may be recommended and presented in a single channel such that the user can view the preferred programs without moving from channel to channel. Of course, multiple channels may also be used to present the personalized contents.

In addition, the video stream may be generated based on certain conditions from the user or users. For example, in regions with low network bandwidth, the high-definition (HD) content may be unsuitable, and transcoding may be performed by server 106 to guarantee the received video streaming can playback smoothly and in a reasonable viewing condition. Other conditions may also be used to configure the video stream.

Further, additionally or optionally, the system 300 may detect video quality and other related conditions (S416). For example, the system 300 may probe the network condition of a household and the capability of the devices that the family members are using, thus the constraints of streaming quality and content resolution are considered in the recommendation content selection. Such conditions are feedback to the system 300 such that the contents can be configured within the constraint of the conditions.

The system 300 may also determine whether the user continues viewing the personalized content channel (S418). If system 300 determines that the user continues the personalized content delivery (S418, Yes), the process 400 continues from S404. On the other hand, if system 300 determines that the user does not want to continue the personalized content delivery (S418, No), the process 400 completes.

The disclosed systems and methods can also be applied to other devices with displays, such as smart phones, tablets, PCs, smart watches, and so on. That is, the disclosed methods not only can be used for systems for delivering the personalized video contents, but also can be applied as the core function for other systems, such as social media systems, other content recommendation systems, information retrieval systems, or any user interactive systems, and so on.

By using the disclosed methods and systems, after receiving media contents or information entities (e.g., images, webpages, documents, etc.) through a network (e.g. the Internet), the feature extraction module may extract the feature values of the received entities. For example, in a social media content system, after the system receives media content entities, the feature extraction module may scale the feature values into a reasonable range to distinguish different entities based on a normal cumulative distribution function. The self-learning module may implement the parameter reinforcement learning process. The parameter reinforcement learning process without external interference is implemented using a probabilistic model constructed by Markov Chain Monte Carlo, such that the distribution over relativeness and irrelativeness of the received entities can be obtained automatically.

That is, based on the obtained distribution over relativeness and irrelativeness of the received entities, the ranking module may rank the received entities by the multi-armed bandit algorithm. Specifically, the entities are ranked based on the upper confidence bound [symbol] +λ [symbol] , where λ is a confidence coefficient; [symbol] is the estimated expectation of the entities; and [symbol] is the standard variance of the entities.

Provided that each entity has a Beta distribution parameter vector π(π_{r,α}, π_{r,β}), the estimated expectation [symbol] and the standard variance [symbol] of the entity are calculated respectively by:

$$\begin{matrix}= \frac{{π}_{r , α}}{{π}_{r , α} + {π}_{r , β}} & ( 22 ) \\ = \sqrt{\frac{{π}_{r , α} * {π}_{r , β}}{{( {π}_{r , α} + {π}_{r , β} )}^{2} * ( {π}_{r , α} + {π}_{r , β} + 1 )}} & ( 23 )\end{matrix}$$

where a parameter vector πᵣ of each entity is known; π_{r,α} indicates the probability of the entity to be helpful; π_{r,β} indicates the probability of the entity to be unhelpful; and shape parameters α, β>0.

Other steps may be referred to above descriptions with respect to the personalized video content delivery system. Further, based on the ranked entities, the system may recommend top-ranked entities to at least one user or may prompt the ranked media contents to the user. For example, in a social media recommendation system, personalized social media information (e.g. Facebook like, Twitter, etc.) may be recommended to a user. In a question and answer system, personalized answer may be provided for the user to solve his/her question.

Other applications, advantages, alternations, modifications, or equivalents to the disclosed embodiments are obvious to those skilled in the art.

What is claimed is:

1. A method for ranking media contents, comprising:
receiving media contents through a network;
extracting feature values of the received media contents;
implementing a parameter reinforcement learning process to obtain automatically distribution over relativeness and irrelativeness of the received media contents; and
based on the obtained distribution over relativeness and irrelativeness of the received media contents, ranking the received media contents by a multi-armed bandit algorithm.

2. The method according to claim 1, further including:
based on the ranked media contents, recommending personalized media contents to at least one user; and
delivering the recommended personalized media contents to the at least one user such that the personalized media contents are presented on the content-presentation device.

3. The method according to claim 1, wherein extracting feature values of the received media contents further includes:
based on feature lists of entities, generating a reasonable range; and
based on a normal cumulative distribution function, scaling feature values into a reasonable range to distinguish different entities.

4. The method according to claim 1, wherein implementing a parameter reinforcement learning process to obtain automatically distribution over relativeness and irrelativeness of the received media contents further includes:
constructing a probabilistic model to infer parameters by Markov Chain Monte Carlo; and
implementing a self-learning process by a restricted Boltzmann machine.

5. The method according to claim 1, wherein ranking the received media contents by a multi-armed bandit algorithm further includes:
calculating an estimated expectation [symbol] of each entity in R reviews;
calculating a standard deviation [symbol] of each entity in the R reviews;
calculating an upper confidence bound of each review; and
based on the upper confidence bounds of the R reviews, ranking the R reviews.

6. The method according to claim 5, wherein:
provided that each entity has a Beta distribution parameter vector π(π_{r,α}, π_{r,β}), the estimated expectation of the review is calculated by:
$$= \frac{{π}_{r , α}}{{π}_{r , α} + {π}_{r , β}}$$
wherein a parameter vector πᵣ of each review is known; π_{r,α} indicates the probability of the review to be helpful; π_{r,β} indicates the probability of the review to be unhelpful; and shape parameters α, β>0.

7. The method according to claim 5, wherein:
provided that each entity has a Beta distribution parameter vector π(π_{r,α}, π_{r,β}), the standard variance of the review is calculated by:
$$= \sqrt{\frac{{π}_{r , α} * {π}_{r , β}}{{( {π}_{r , α} + {π}_{r , β} )}^{2} * ( {π}_{r , α} + {π}_{r , β} + 1 )}}$$
wherein the parameter vector πᵣ of each review is known; π_{r,α} indicates the probability of the review to be helpful; π_{r,β} indicates the probability of the review to be unhelpful; and shape parameters α, β>0.

8. The method according to claim 7, wherein:
the reviews are ranked based on the upper confidence bound [symbol] +λ [symbol] , wherein λ is a confidence coefficient; [symbol] is the estimated expectation of the review; and [symbol] is the standard variance of the review.

9. A system for ranking media contents, comprising:
a feature extraction module configured to extract feature values of the received media contents;
a self-learning module configured to implement a parameter reinforcement learning process to obtain automatically distribution over relativeness and irrelativeness of the received media contents; and
a ranking module configured to rank the received media contents by a multi-armed bandit algorithm based on the obtained distribution over relativeness and irrelativeness of the received media contents.

10. The system according to claim 9, further including:
a recommendation engine configured to, based on the ranked media contents, recommend personalized media contents to at least one user; and
a video stream renderer configured to deliver the recommended personalized media contents to the at least one user such that the personalized media contents are presented on the content-presentation device.

11. The system according to claim 9, wherein the feature extraction module further includes:
a range scaling unit configured to generate a reasonable range based on feature lists of entities; and
a feature scaling unit configured to scale feature values into a reasonable range to distinguish different entities based on a normal cumulative distribution function.

12. The system according to claim 9, wherein the self-learning module further includes:
a probabilistic model generating unit configured to construct a probabilistic model to infer parameters by Markov Chain Monte Carlo; and
a restricted Boltzmann Machine processing unit configured to implement a self-learning process by a restricted Boltzmann machine.

13. The system according to claim 9, wherein the ranking module includes:
an expectation calculation unit configured to calculate an estimated expectation [symbol] ; of each entity in R reviews;
a deviation calculation unit configured to calculate a standard deviation [symbol] of each entity in the R reviews; and
a potential reward calculation and ranking unit configured to calculate an upper confidence bound of each review and rank the R reviews based on the upper confidence bounds of the R reviews.

14. The system according to claim 13, wherein:
provided that each entity has a Beta distribution parameter vector π(π_{r,α}, π_{r,β}), the estimated expectation of the review is calculated by:
$$= \frac{{π}_{r , α}}{{π}_{r , α} + {π}_{r , β}}$$
wherein a parameter vector πᵣ of each review is known; π_{r,α} indicates the probability of the review to be helpful; π_{r,β} indicates the probability of the review to be unhelpful; and shape parameters α, β>0.

15. The system according to claim 13, wherein:
provided that each entity has a Beta distribution parameter vector π(π_{r,α}, π_{r,β}), the standard variance of the review is calculated by:
$$= \sqrt{\frac{{π}_{r , α} * {π}_{r , β}}{{( {π}_{r , α} + {π}_{r , β} )}^{2} * ( {π}_{r , α} + {π}_{r , β} + 1 )}}$$
wherein the parameter vector πᵣ of each review is known; π_{r,α} indicates the probability of the review to be helpful; π_{r,β} indicates the probability of the review to be unhelpful; and shape parameters α, β>0.

16. The system according to claim 15, wherein:
the reviews are ranked based on the upper confidence bound [symbol] +λ [symbol] , wherein λ is a confidence coefficient; [symbol] is the estimated expectation of the review; and [symbol] is the standard variance of the review.
